(19) United States
(12) Patent Application Publication
(10) Pub. No.: US 2005/0268000 A1
(43) Pub. Date: Dec. 1, 2005

(54) Accessory identifier in an electronic device

(76) Inventor: Mark J. Carlson, Round Lake, IL (US)

Correspondence Address: MOTOROLA INC, 600 NORTH US HIGHWAY 45, ROOM AS437, LIBERTYVILLE, IL, 60048-5343, US

(21) Appl. No.: 10/857,123

(22) Filed: May 28, 2004

(51) Int. Cl. G06F 13/00

(52) U.S. Cl. 710/15

(57) ABSTRACT

An apparatus (100) and a method (200) for an accessory identifier for identifying a connected accessory type from three or more accessory types (102, 104, 106) are provided. Each of the three or more accessory types (102, 104, 106) has a unique identifier resistor (108, 110, 112), which is accessible through an identification pin (114, 116, 118) and is linearly related to each other in resistance value. Using a voltage source (120), presence of the connected accessory (102) is detected (204) by monitoring a voltage change at the source pin (126). Once the presence is detected, a predetermined current is sent through the source pin (126) and the resulting voltage at the source pin (126) is measured (208), and based upon the measured voltage, the connected accessory type (102) is identified (210).

### FIELD OF THE INVENTION

The present invention generally relates to a data bus connection, and more specifically to detection and identification of an accessory attachment through the data bus connection.

### BACKGROUND OF THE INVENTION

Portable electronic devices, such as personal digital assistants (“PDAs”), personal computers (“PCs”) and cellular telephones, are generally capable of accepting external accessories such as, but not limited to, a camera, a speaker phone, and a battery charger. An electronic device, which supports the “Mini USB Analog Carkit Interface Specification” (“CEA-936”) published by Consumer Electronics Association, Dec. 1, 2002, is required to detect presence of an accessory at all times through an identification (“ID”) pin of a connector that accepts the accessory. In addition, the ID pin is also used to identify the type of the accessory attached to the electronic device. Presently, the identification of accessory types is implemented by using a regulated voltage and precision resistors to make a precise measurement of the ID pin voltage. The measured ID pin voltage is then used to determine what accessory is currently attached to the electronic device. However, the use of a regulated voltage and precision resistors adds overall cost to the electronic device in terms of number of parts required for the implementation or as an integration cost for the required parts.

Presently, different resistance values to ground are commonly used in external bus designs for detection and identification of accessories. However, because the CEA-936 interface is designed to be compatible with the existing Universal Serial Bus (“USB”) interface, the range of identification resistors becomes very limited, typically in excess of 100 kΩ, which necessitates tighter tolerance and higher precision methods for detecting and identifying accessories. Further, because the electronic device is required to detect presence of an accessory at all times through the ID pin, the design using different resistance values to ground for detection and identification of accessories carries the burden of higher current drain due to the fact that the regulated supply must be on at all times.

### BRIEF DESCRIPTION OF THE DRAWINGS

FIG. 1 is a block diagram of an accessory identifier in accordance with the preferred embodiment; and

FIG. 2 is a flowchart for an accessory identifier in accordance with the preferred embodiment.

### DETAILED DESCRIPTION OF THE PREFERRED EMBODIMENTS

The accessory identifier provides an apparatus and a method in an electronic device for detecting and identifying an attached accessory from various attachable accessories. Each of the attachable accessories has a unique resister, or an identification resister, connected between an identification pin of the attachable accessory and ground. In a detection mode, the electronic device applies a predetermined voltage provided by a voltage source at a source end of a pullup resister, which is designed to connect to the identification pin of an attachable accessory at a receiving end upon attachment. A change in voltage at the receiving end is monitored to detect presence of the attachable accessory. If there was no attachment, the voltage at the receiving end would be the full predetermined voltage of the voltage source because it is an open circuit. However, if there was an accessory attached, then the pullup resister and the identification resister of the attached accessory would form a voltage divider, and the voltage at the receiving end would be proportionate to a resistance ratio of the pullup resister and the identification resister. In the detection mode, it suffices to notice a change in voltage from the predetermined voltage at the receiving end of the pullup resister to determine the attachment or removal of an accessory. Once the presence is detected, the electronic device then identifies the attached accessory based upon the identification resistor. Instead of continuing to use the voltage divider, which would require a regulated voltage source and exponentially increasing identification resistor values to differentiate types of accessories, an identification mode based upon a current source is used. By providing a predetermined current to the identification resistor, resistance values used to differentiate accessories can be linearly spaced instead of exponentially spaced as in the voltage divider method, and the regulated voltage source is no longer required.

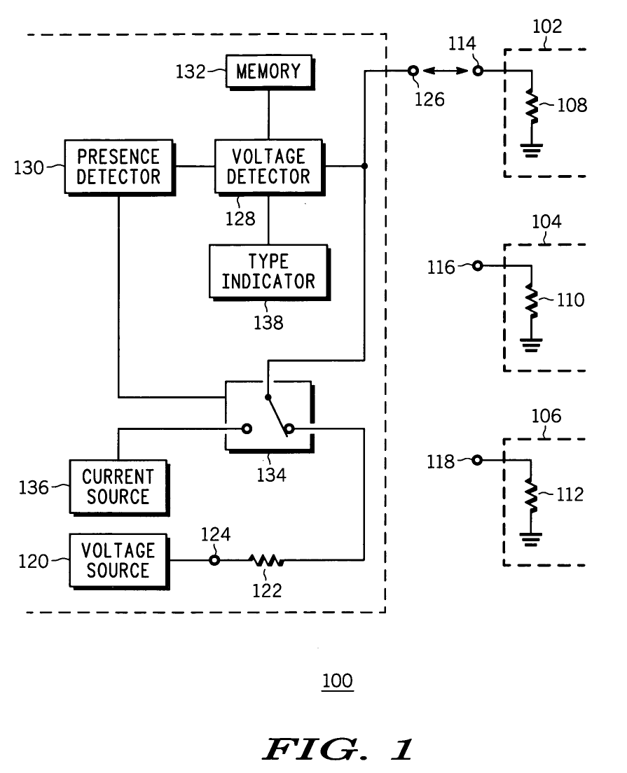

FIG. 1 is a block diagram of an accessory identifier 100 in accordance with the preferred embodiment. The accessory identifier 100 is configured to identify a connected accessory type 102 from three or more accessory types (only three accessory types 102, 104, and 106 are shown). Each accessory type 102, 104, and 106 has a unique identification resister 108, 110, and 112 accessible through an identification pin 114, 116, and 118. The accessory identifier 100 has a voltage source 120, which is connected to a source resister 122 at its source end 124, and is configured to apply a predetermined voltage at the source end 124. The source resister 122 is also coupled to a source pin 126, which is designed to connect to the identification pin 114, 116, or 118 when an accessory is attached. A voltage detector 128 is coupled to the source pin 126, and is configured to monitor the voltage at the source pin 126. A presence detector 130 is coupled to the voltage detector 128 to detect presence of the connected accessory 102 based upon a change in the measured voltage at the source pin 126. When there is no accessory connected, the source resister 122 is an open circuit and the voltage at the source pin 126 is the predetermined voltage supplied by the voltage source 120. However, when there is an accessory attached, such as the connected accessory 102, the source resister 122 and the identification resister 108 function as a voltage divider, and the voltage at the source pin 126 is less than the predetermined voltage of the voltage source 120. The voltage detected at the source pin 126 may be stored in a memory 132, which is coupled to the voltage detector 128. The presence detector 130 may compare the stored voltage against the measured voltage at the source pin 126 to detect a change in voltage and to determine when the connected accessory 102 has been removed.

Once the presence of a connected accessory 102 is detected, a mode switch 134, which is coupled to the presence detector 130, disconnects the source resister 122 from the source pin 126, and connects a current source 136 to the source pin 126, enabling a predetermined current from the current source 136 to flow through the identification resistor 108 of the connected accessory 102. Because the predetermined current is a known fixed value, the resistance of the identification resistor 108 can be calculated based upon the measured voltage at the source pin 126. A type indicator 138, which is coupled to the voltage detector 128, is configured to identify the identification resistor 108 based upon the measured voltage. Further, based upon the identity, or the resistance value, of the identification resistor 108, the type indicator 138 is configured to determine the type of the connected accessory 102. By using the current source 136 to generate voltage across an identification resister 108, 110, or 112, resistance values for the identification resisters 108, 110, and 112 can be linearly spaced to provide sufficiently different voltages at the source pin 126 to determine the type of the connected accessory. In a voltage divider method, using the voltage source 120 and the voltage detector 128 to determine the type of the connected accessory based on the divided voltage at the source pin 126, the resistance values used for the identification resistors need to be spaced exponentially to produce sufficient voltage difference among the accessory types. For example, setting the voltage source 120 to be 2 V, the source resister 122 to be 100 kΩ, and the first identification resistor for the first accessory type to be 100 kΩ producing 1 V at the source pin 126, then the subsequent resistors for different accessory types and the resulting voltages at the source pin 126 would be as follows: 200 kΩ producing 1.33 V; 400 kΩ producing 1.6 V; 800 kΩ producing 1.78 V; 1600 kΩ producing 1.88 V; 3200 kΩ producing 1.94 V. As shown, the voltage difference between accessory types rapidly diminishes as the number of types increase. To measure the diminishing differences, the voltage divider method would require a high precision voltage source and high precision voltage detector as well as high precision resistors for the identification resistors. However, in a current source method using the current source 136, the resistance values used for the identification resistors can be spaced linearly to produce sufficient voltage difference among the accessory types. For example, setting the current source 136 to provide 5 μA and the first identification resistor for the first accessory type to be 100 kΩ producing 0.5 V at the source pin 126, then to produce a voltage difference of 0.1 V in the subsequent accessory types, the resistors for the subsequent accessory types and the resulting voltages at the source pin 126 would be as follows: 120 kΩ producing 0.6 V; 140 kΩ producing 0.7 V; 160 kΩ producing 0.8 V; 180 kΩ producing 0.9 V; 200 kΩ producing 1.0 V; 220 kΩ producing 1.1 V; 240 kΩ producing 1.2 V; 260 kΩ producing 1.3 V; 280 kΩ producing 1.4 V; 300 kΩ producing 1.5 V; and may extend up to the maximum detectable voltage. By using the current source 136, the voltage difference among the accessory types does not diminish as the number of accessories increase. Further, the current source method does not require high precision voltage source, high precision voltage detector, or high precision resistors for the identification resistors. Alternatively, the current source 136 may vary the current until a predetermined voltage is measured at the source pin 126, and then the current required to produce the predetermined voltage may be correlated to determine the type of the connected accessory 102.

To reduce power consumption, once the connected accessory 102 is identified, the mode switch 134 disables the current source 136 and re-connects the source resister 122 to the source pin 126 so that the removal of the connected accessory 102 can be detected by detecting a change in voltage at the source pin 126.

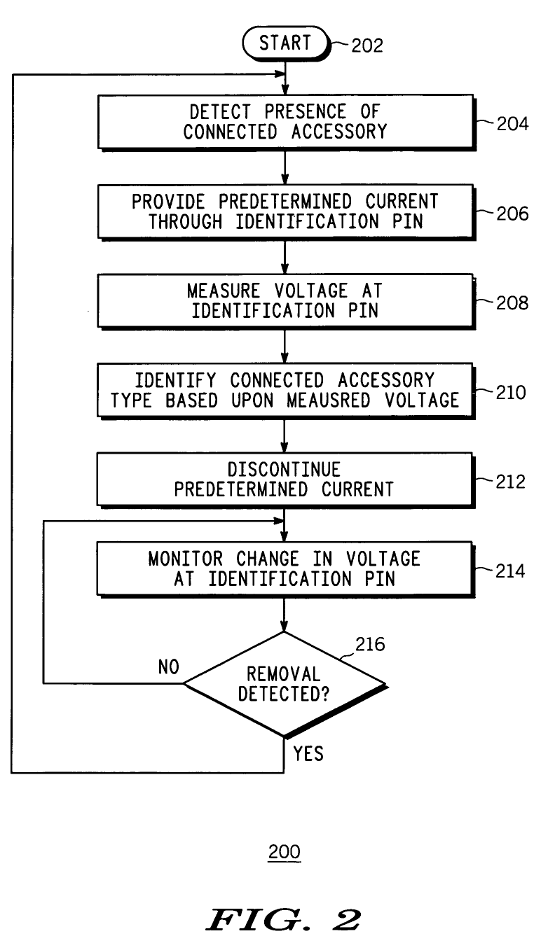

FIG. 2 is a flowchart 200 of an accessory identifier in accordance with the preferred embodiment. The process begins in block 202, and presence of a connected accessory type 102 is detected in block 204. The presence of the connected accessory type 102 may be accomplished by monitoring voltage change at the identification pin 114, which is connected to the source pin 126. Once the presence is detected, a predetermined current from the current source 136 is provided through the identification pin 114 in block 206. The predetermined current generates voltage across the identification resister 108, and the generated voltage is measured at the identification pin 114 in block 208, and based upon the measured voltage, the connected accessory type 102 is identified in block 210. Alternatively, the current source 136 may vary the current until a predetermined voltage is measured at the source pin 126, and then the current required to produce the predetermined voltage may be correlated to determine the type of the connected accessory 102. Once the connected accessory type 102 is identified, the predetermined current is discontinued in block 212, which reduces power consumption, and the monitoring of a change in voltage at the identification pin 114 is resumed in block 214. If the removal is detected in block 216, then the process loops back to block 204, and begins again to detect for presence of a connected accessory. Otherwise, the monitoring of a change in voltage at the identification pin 114 is continued in block 214.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. An accessory identifier configured to identify a connected accessory type from three or more accessory types, each of the three or more accessory types having a unique identifier resistor accessible through an identification pin, the accessory identifier comprising:
a source pin configured to connect to the identification pin of any one of the three or more accessory types;
a current source switchably coupled to the source pin, the current source configured to provide a predetermined current to the unique identifier resistor of the connected accessory type of the three or more accessory types;
a voltage detector coupled to the source pin, the voltage detector configured to measure a voltage at the source pin; and
a type indicator coupled to the voltage detector, the type indicator configured to identify the connected accessory type of the three or more accessory types based upon the measured voltage,
wherein the unique identification resister of each of the three or more accessory types is linearly related in resistance value to other unique identification resisters of the three or more accessory types.

2. The accessory identifier of claim 1, further comprising:
a source resister coupled to the source pin;
a voltage source coupled the source resister, the voltage source configured to provide a predetermined voltage to the source resister;
a presence detector coupled to the voltage detector, the presence detector configured to detect presence of the connected accessory type based upon a change in the measured voltage at the source pin; and
a mode switch coupled to the presence detector, the mode switch configured to enable the current source upon detecting the presence of the connected accessory type.

3. The accessory identifier of claim 2, wherein the mode switch is further configured to disconnect the source resister from the source pin upon detecting the presence of the connected accessory type.

4. The accessory identifier of claim 3, wherein the mode switch is further configured to disable the current source and to re-connect the source resister to the source pin upon identifying the connected accessory type.

5. The accessory identifier of claim 2, further comprising:
a memory coupled to the voltage detector, the memory configured to store a detection voltage measured at the source pin when the presence of the connected accessory type is detected,
wherein the change in the measured voltage at the source pin is based upon a deviation from the stored detection voltage.

6. The accessory identifier of claim 2,
wherein the predetermined current produces a predetermined voltage at the source pin, and
wherein the type indicator is further configured to identify the connected accessory type of the three or more accessory types based upon the predetermined current that produces the predetermined voltage at the source pin.

7. Three or more accessory types configured to connect to an electronic device, each of the three or more accessory types comprising:
an identification pin configured to receive a predetermined current; and
a unique identifier resistor coupled to the identification pin, the unique identification resister configured to produce a predetermined voltage based upon the predetermined current, the predetermined voltage indicative of one of the three or more accessory types,
wherein each unique identifier resistor of the three or more accessory types is linearly related in resistance value to each other.

8. The three or more accessory types of claim 7, wherein the predetermined current is equal in value for all of the three or more accessory types.

9. The three or more accessory types of claim 7, wherein the predetermined current is a current sufficient to produce a predetermined voltage at each identification pin of the three or more accessory types.

10. A method in an electronic device for identifying a connected accessory type through an identification pin, the method comprising:
detecting presence of the connected accessory type at the identification pin;
providing a predetermined current through the identification pin upon detecting the presence of the connected accessory type;
measuring a voltage at the identification pin; and
identifying the connected accessory type based upon the measured voltage at the identification pin.

11. The method of claim 10, wherein detecting presence of the connected accessory type at the identification pin includes monitoring a change in voltage at the identification pin.

12. The method of claim 10, further comprising:
enabling the providing of the predetermined current upon detecting the presence of the connected accessory type.

13. The method of claim 10, further comprising:
disabling the providing of the predetermined current upon identifying the connected accessory type.

14. The method of claim 10, further comprising:
re-monitoring a change in voltage at the identification pin upon identifying the connected accessory type.

15. The method of claim 10,
wherein the predetermined current produces a predetermined voltage at the identification pin, and
wherein identifying the connected accessory type based upon the measured voltage at the identification pin includes identifying the connected accessory type based upon the predetermined current that produces the predetermined voltage at the identification pin.
